(19) United States
(12) Patent Application Publication
(10) Pub. No.: US 2015/0338377 A1
(43) Pub. Date: Nov. 26, 2015

(54) Eddy Current Inspection Probe

(71) Applicant: Zetec, Inc., Snoqualmie, WA (US)

(72) Inventors: Jeffrey Raymond Gueble, Bainbridge Island, WA (US); David Sullivan, Seattle, WA (US); Jevne Branden Micheau-Cunningham, Seattle, WA (US)

(21) Appl. No.: 14/717,631

(22) Filed: May 20, 2015

Related U.S. Application Data
(60) Provisional application No. 62/000,905, filed on May 20, 2014.

(51) Int. Cl. G01N 27/90; G21C 17/017

(52) U.S. Cl. CPC G01N 27/9006; G21C 17/017

(57) ABSTRACT

A device and method of eddy current based nondestructive testing of tubular structures made of electrically conductive materials is disclosed. The probe includes means for producing an electromagnetic field for inducing an eddy current in a device under test, means for sensing eddy current signals in the device under test, and an analog to digital converter, wherein the analog to digital converter is conditioned to receive the sensed eddy current signals and to transmit a digital signal related to the eddy current signals.

### CROSS REFERENCE TO RELATED APPLICATION

This utility application claims the benefit under 35 U.S.C. §119(e) of provisional application Ser. No. 62/000,905 filed on May 20, 2014, and entitled “Eddy Current Probe.”The entire disclosure of the provisional application is incorporated herein by reference.

### FIELD OF THE INVENTION

The invention is directed to sensor probes for eddy current non-destructive testing.

### BACKGROUND

Eddy Current Probes are well known and widely used for inspecting nuclear steam generator tubing. The probes contain one or more coils which are driven with oscillating electrical currents. The probes traverse each of the thousands of tubes present in a reactor cooling system. The presence of defects in a tube causes the electrical currents in the coils to change, which is measured and displayed to an operator and/or recorded to a file. There is very little circuitry present in the probes themselves. Probes typically contain only the coils and a multiplexer for connecting various coils to umbilical wires in a specified sequence. By sharing the umbilical wires between several probes, the number of wires required in the umbilical is significantly reduced.

The number of wires which can be carried in an umbilical is limited, as it must fit within a narrow tube and be flexible enough to bend easily around a sharp radius. This architecture therefore imposes an upper limit on the number of probe coils which can be supported. The use of a long umbilical also causes issues with signal integrity. The cable must be constructed to minimize crosstalk between channels and minimize any loss in signal resulting from cable resistance. Because of the large number of wires that are present in an umbilical, there is insufficient room to use a connector pair to interface between the umbilical and the probe. The umbilical wires must therefore be soldered directly to a printed circuit board (PCB) within the probe. This soldering is a labor-intensive operation which significantly affects cost and reliability.

Thus a means for reducing the number of wires attached to an eddy current probe is needed.

### BRIEF DESCRIPTION OF THE DRAWINGS

The objects, aims, features, aspects and attendant advantages of the invention will become clear to those skilled in the art from a consideration of the following detailed description, taken in conjunction with the accompanying Figures of drawing, in which:

FIG. 1 is a system block diagram of electronics for an exemplary probe; and

FIG. 2 is a drawing of an exemplary multiple coil probe array.

### DESCRIPTION

In an embodiment of the novel apparatus there is an eddy current probe having digitized eddy current drive and pickup signals within a tethered probe head including: a digital drive signal converted into analog drive waveforms, analog pickup waveforms converted into digital signals and transmission to external data processing equipment. The digitization and communications is wholly contained within a probe suitable for insertion into heat exchanger tubing of inside diameter less than one inch, traversing the length of the tube while tethered to external data storage and processing equipment.

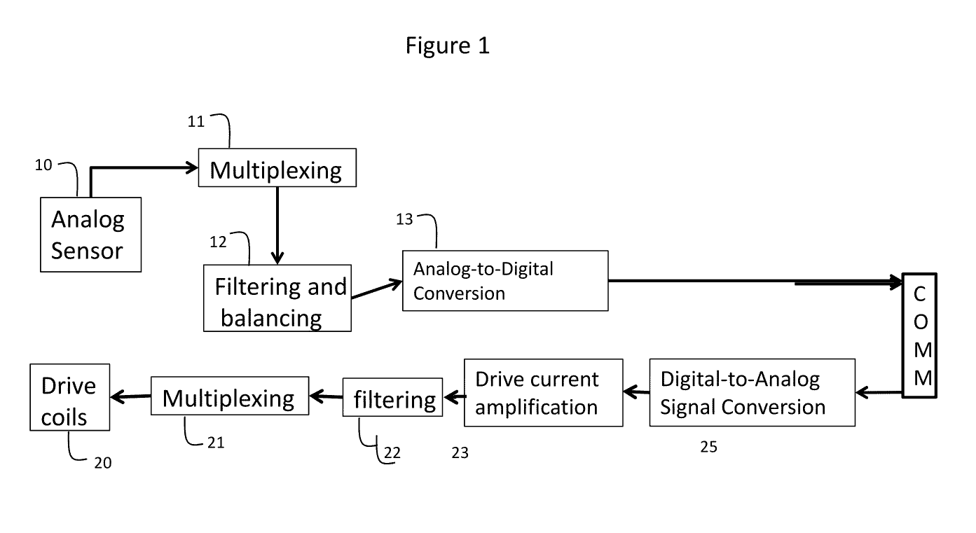

The novel probe involves two main elements: First, there is the packaging of electronic components necessary to perform the digital to analog conversion for the drive signal and the subsequent analog to digital conversion of the sense signal within the available envelope of small diameter tubing which allow the electronics to traverse tight bends and enable the item to be pushed or pulled through lengths up to 160 feet. To achieve this, the electronics are divided into a series of modules sized to enable the entire package to traverse a bend radius down to 3 inches. Connections between modules may be coax wire soldered connections or flexible circuit. Second, there involves unique signal processing to allow information to be condensed for transmission back to the instrument to enable increase in sensing channels that can be supported. With reference to FIG. 1 as an exemplary embodiment, there is shown a block diagram of electronics for incorporation into a multiple coil array eddy current probe. At the left end of FIG. 1 are shown the electronic elements that interface with the probe drive coils 20 and the eddy current sensors 10. As the embodiment includes a plurality of current sensors, the sensor signals are multiplexed by a multiplexer circuit 11. At the output of the multiplexer circuit there are filtering and balancing circuits 12. The electronics required to do the balancing consists of 2 quad op-amps, some passive components (resistors and capacitors), and voltage regulators. Three separate forms of balancing signals are required for: 1) circumferential array coil measurements, 2) axial array coil measurements and 3) Absolute bobbin coil measurements. The output of the filtering and balancing circuits is connected to an analog to digital converter 13.

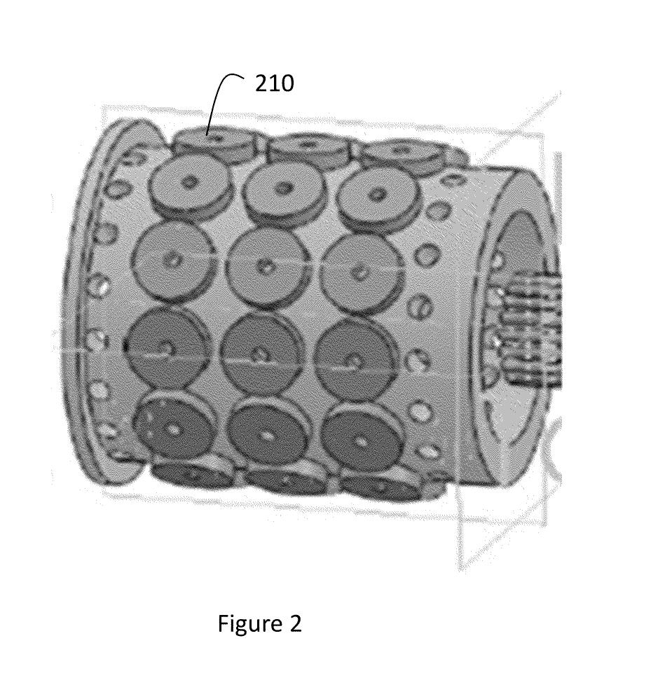

The eddy current probe may include array and/or bobbin coils. FIG. 2 shows an exemplary probe with 1 12×3 array of coins. slightly different. The principal difference between the two is that that array coils are processed individually as single-ended inputs, while bobbin coils are processed as differential inputs, with one differential input consisting of the two bobbin coils and the other consisting of one bobbin and a balance signal.

With respect to the drive coils 20 there is depicted in FIG. 1 an embodiment wherein a digital signal is received at the probe head over a communication link COMM. The digital excitation signal is converted to an analog signal by a D/A converter 25. The output of the converter is amplified by an amplifier 25, filtered by a filter 22 and multiplexed 21 out to the drive coils 20. Up to 5 frequency components, ranging in frequency from 25 kHz to 800 kHz, may be present simultaneously in an excitation signal. These are all produced by the DAC. The total voltage is limited to +/−10V including all frequency components. In addition to controlling the multiplexing of various coils, the drive circuitry (21, 22, 23, 24, 25, 26) is capable of dividing up time periods into slots, each of which has a different configuration or context. A context is defined by its length, frequency components, and the relative amplitude and phase of each component. Each time slot configuration can accommodate up to five simultaneous frequencies and would occur in conjunction with a separate multiplexer increment. The time slot must be long enough to allow at least one cycle at the lowest frequency, and to allow for settling time of the multiplexer.

### Data Processing and Transmission

Demodulation and summing of sensor signals can either be performed onboard the probe wherein digital data is then at low rate to an external instrument, or raw signal data can be digitized and sent at high rate to the external instrument. For each channel, the incoming time series is multiplied by a sine and cosine at each waveform. This results in a time series of in-phase and quadrature data for each frequency, for each time slot. In-phase and quadrature data are separately summed for each time slot, yielding one output point per frequency, per time slot. For non-multiplexed data, an IIR filter may be applied. The sums are scaled to averages using shift and/or multiply operations. The operating point is moved to zero, depending on when the last null was commanded by the user. The balance signal is added to the absolute bobbin signal to remove the carrier. The balance signal is generated using an iterative software procedure. This task is carried out only when commanded by the user. After the signal is generated, it is synthesized using a phase accumulator and sine lookup table, before being output to a digital to analog converter.

Performing demodulation and summing in the probe drastically reduces the required data rate, but it increases the complexity of the digital circuitry in the probe. For example: incoming data samples at 5 MSPS from each of the multiple ADCs must be multiplied by a sine and cosine to transform the data into in-phase and quadrature pairs. A different sine and cosine pair must be used for each frequency. The resulting in-phase and quadrature samples must then be summed over one time slot. After scaling this value can be stored in a First-In-First-Out (FIFO) RAM block where it awaits transmission to the instrument.

### Multiplexers

With a multiple coil array type probe, there is a need to multiplex coils to a limited number of ADCs. In an exemplary probe, as shown in FIG. 2 there is an array of 3 rows of 12 coils 210 Typically, at any given time two coils would be energized at the same time, on opposite sides of the probe body. For each of the two drive coils, signals will be received from three other coils (one circumferential measurement and two axial measurements). The 12×3 array can be considered to consist of two 6×3 arrays in series. For each of the two arrays, 4 of the 18 coils in one of these halfarrays must be connected to 1 driver input and 3 ADC inputs. Because there are some constraints on which coils need to connect to which inputs, the interconnections can be handled using, for example, two Analog Devices ADG1407 integrated circuits, each of which contain two 8:1 multiplexers.

What is claimed is:

1. An eddy current probe for nondestructive testing of tubular structures made of electrically conductive materials comprising:
a plurality of eddy current drive coils;
a plurality of eddy current sensors;
a first multiplexer configured to receive signals from said plurality of eddy current sensors;
an analog to digital converter configured to receive multiplexed signals from said first multiplexer and to convert said multiplexed signals to a multiplexed digital signal.

2. The eddy current probe of claim 1, further comprising a digital to analog converter configured to receive digital drive signals and convert said digital drive signals an analog signal for driving said drive coils.

3. The eddy current probe of claim 2, further comprising a drive current amplifier, a filter and a multiplexer, said drive current amplifier configured to amplify said analog signal for driving said drive coils, said filter configured to filter said amplified analog signal and said multiplexer configured to direct said analog signal to one of said plurality of eddy current drive coils.

4. The eddy current probe of claim 1, wherein said eddy current sensors are a circumferential array of sensors.
